(19) United States
(12) Patent Application Publication
(10) Pub. No.: US 2025/0029183 A1
(43) Pub. Date: Jan. 23, 2025

(54) SYSTEM AND METHOD FOR GEOGRAPHIC AREA-BASED AUTOMATED ADVISING

(71) Applicant: Wells Fargo Bank, N.A., San Francisco, CA (US)

(72) Inventor: Carrie Anne Hanson, Charlotte, NC (US)

(21) Appl. No.: 18/050,167

(22) Filed: Oct. 27, 2022

(51) Int. Cl. G06Q 40/06; G06Q 40/02; G06Q 40/08

(52) U.S. Cl. CPC G06Q 40/06; G06Q 40/03; G06Q 40/08

(57) ABSTRACT

Aspects of the present disclosure address systems and methods for providing a list of financial filters, receiving, from a user, a selection of one or more of the financial filters and a target geographic area, and applying the selection of the one or more financial filters and the target geographic area to match a set of matched geographic areas from a data store, wherein the matched geographic areas are geographically included as part of the target geographic area. The systems and methods additionally include retrieving financial information, demographic information, or a combination thereof, for the set of matched geographic areas when a match is found, and presenting, via a display, the set of matched geographic areas, the financial information, the demographic information, or a combination thereof.

### TECHNICAL FIELD

The present disclosure generally relates to automated advising, and more specifically to geographic area-based automated advising

### BACKGROUND

Geographic areas, such as neighborhoods, include certain geographic compositions of residential homes, places of business, schools, and so on. Different neighborhoods may include different geographic compositions. Homeowners and renters can look at various geographic compositions to discover neighborhoods of interest.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document. Various ones of the appended drawings merely illustrate example embodiments of the present inventive subject matter and cannot be considered as limiting its scope.

FIG. 1 is a flowchart illustrating a process for applying financial filters to match certain geographic areas, and to present financial information for the matched geographic areas, according to some example embodiments.

FIG. 2 is a flowchart displaying a process for the presentation of matched geographic areas and related financial and/or demographic information, as well as for presentation of adverts, according to some example embodiments.

FIG. 3 is a map display of three matched geographic areas, according to some example embodiments.

FIG. 4 depicts a visualization of certain virtual structures created via financial and/or demographic information from matched geographic areas, according to some example embodiments.

FIG. 5 illustrates a visualization of an interior space corresponding to an interior of a virtual structure, according to some example embodiments.

FIG. 6 is a block diagram depicting a machine suitable for executing instructions via one or more processors, according to some example embodiments.

### DETAILED DESCRIPTION

Reference will now be made in detail to specific example embodiments for carrying out the inventive subject matter. Examples of these specific embodiments are illustrated in the accompanying drawings, and specific details are set forth in the following description in order to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

The techniques described herein solve various technical problems such as analyzing large amounts of disparate data to provide for focused findings useful in real estate transactions, moving to a new area, and financial comparing different geographic areas. For example, the techniques described herein provide for automating the analysis, comparison, and the creation of visualizations of geographic areas such as neighborhoods filtered on certain financial data. In one example, a user can enter a set of financial filters (e.g., home down payment percent, average savings by resident, spending habits of residents, and so on) and a target geographic area to apply the financial filters to. A geofinancial matching system then matches a set of geographic areas located within the target geographic area based on the financial filters entered. The geographic areas can include a state, a city, a county, a municipality, one or more neighborhoods, and/or a subarea within a neighborhood. In certain examples, the financial filters can also be automatically extracted for matching, for example, by selecting a source geographic area to extract the financial filters from. Accordingly, the user can select a specific neighborhood as the source geographic area to find other financially similar geographic areas based on the automatically extracted financial filters.

Financial information and/or demographic information for the matched geographic areas, such as average income, types of investments used (e.g., qualified tuition plans, retirement savings accounts, and so on), average type of home, spending habits, credit card usage, gender percentages, marriage percentages, average number of children, and the like, is then presented to the user in various ways. In some examples, the financial and/or demographic information is presented via augmented reality, virtual reality, and/or mixed reality techniques. The financial and/or demographic information can also be presented via graphs, charts, and/or static visualizations, including certain reports, as further described below. Accordingly, a more diverse and immersive presentation of the financial and/or demographic information is provided.

Data used for matching or otherwise discovering certain geographic areas include public data stores, such as county and state tax assessment databases, census databases, governmental agency databases (e.g., U.S. Bureau of Economic Analysis databases, U.S. Department of Commerce databases), as well as private institutions and data submitted voluntarily, e.g., by members of a neighborhood. Certain data may be anonymized. For example, a banking institution may provide for anonymized data store(s) that remove identifying information in compliance with local, state, and national laws.

As users discover new geographic areas of interest and navigate through financial information, certain advertisements or focused offers may be automatically presented. For example, when navigating through retirement information, an offer for a retirement account may be presented, along with a mechanism (e.g., a link) to a service provider that can provision the retirement account. Likewise, insights or advice from other entities, such as neighborhood residents who volunteer the advice, is provided. For example, advice on how residents fulfilled all payments on a mortgage, took out a car loan, paid for college tuition, and so on, can be provided as the user investigates a geographic area and/or financial information related to the geographic area. By matching geographical areas based on a variety of financial filters and by providing for diverse financial information and advice for matched areas, the techniques described herein enable a more efficient and flexible approach to house hunting, real estate investing, and financial advice, among others.

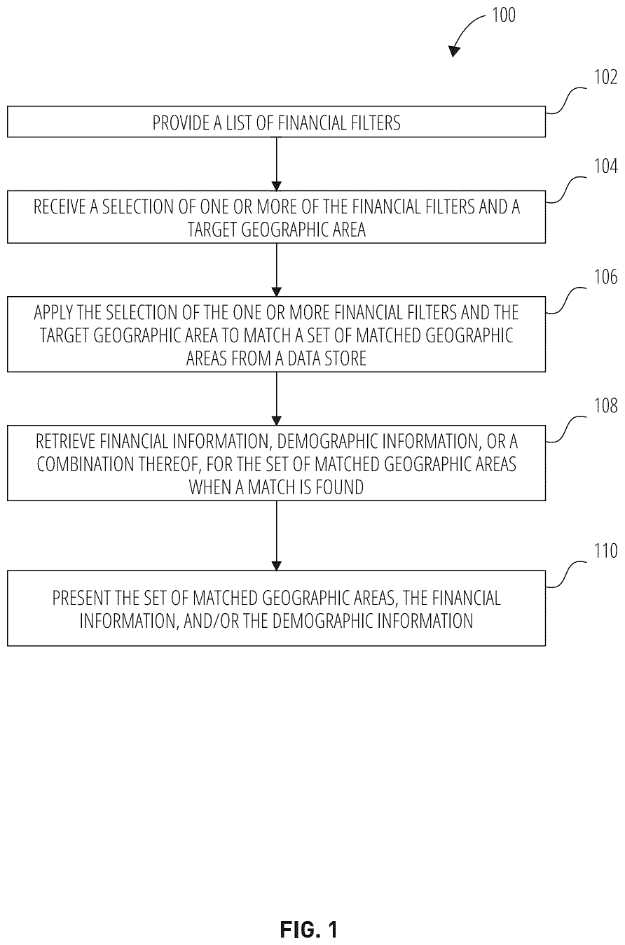

Turning now to FIG. 1, the figure is a flowchart of a process 100 suitable for applying financial filters to match certain geographic areas, and to present financial information for a set of matched geographic areas, according to certain examples. In the depicted embodiment, the process 100 provides, at block 102, a list of financial filters, for example, via a graphical user interface (GUI) included in an application (e.g., app), a website, a computing device, and the like. The financial filters include financial information to be applied to a target geographic area, such as an average and/or median down payment percent for an asset (e.g., a home, a car, a building), an average and/or median mortgage, and average and/or median other asset loans (e.g., vehicle loans), and average and/or median income per resident and/or per household, an average and/or median total savings per resident and/or per household, an average and/or median savings rate per resident and/or per household, an average and/or median net worth per resident and/or per household, an average and/or median number of credit cards per resident and/or per household, and average and/or median credit card debt per resident and/or per household, an average and/or median savings per account type (e.g., bank savings account, retirement accounts such as 401K accounts and IRA accounts), an average and/or median for miscellaneous investment accounts, an average and/or median cryptocurrency investment per cryptocurrency (e.g., Bitcoin, Ethereum, Doge coin, and so on), an average and/or median rent, an average and/or median utilities spending per utility category (e.g., electricity, water, gas, heating oil, internet, cellphone), an average and/or median grocery spending per resident and/or per household, an average and/or median travel spending per resident and/or per household, an average and/or median transportation spending per resident and/or per household, an average and/or median entertainment spending per resident and/or per household, an average and/or median childcare cost per child and/or per household, an average and/or median pet care cost per resident and/or per household, an average and/or median healthcare spending by healthcare category (e.g., preventative care, emergency healthcare, dental, elder care, and so on) per resident and/or per household, or a combination thereof.

The process 100 then receives, at block 104, a selection of the one or more of the financial filters and a target geographic area. For example, a user selects a subset of the one or more financial filters that are of interest, assigns a value or range of values for each selected financial filter, and additionally selects a target geographic area to apply the financial filters to. The user selection can also include selecting a ranking of the financial filters in order of importance to the user. For example, the user, via a GUI, can move the selected financial filters up or down in a list to create a desired order of ranking, where the top financial filter is ranked as more important the next financial filter, and so on down the list. The financial filters can also be assigned a “weight” by the user, where higher weights give the financial filter a higher importance when the financial filters are applied. Weights can range from 0, or no importance, to 100, or very high importance. In addition to fixed values, the financial filters may also include ranges, such as filtering for mortgages between $175,000 to $250,000, filtering for average grocery spending of between $300 to $400 monthly, and so on.

The target geographic area of interest can include a state, a city, a municipality, a neighborhood, and/or an area inside a neighborhood. The user can select the target geographic area by entering the name of the desired area of interest (e.g., Philadelphia, downtown Dallas, etc.) and/or by using a map GUI to select the target geographic area. For example, the map GUI may enable the “lassoing” or the graphical selection of a target geographic area via shapes (e.g., square, circle, freeform shape) in a map to be used as the target geographic area for the application of the financial filters.

In some examples, the financial filters are selected, at block 104, by selecting a source geographic region to automatically extract the financial filters from. Accordingly, some or all of the financial filters are based on the source geographic area. In these examples, the source geographic area, via the extracted financial filters, will be used to find financially similar geographic areas in the target geographic area, e.g., geographic areas that include or otherwise match the financial filters included in the source geographic area. The extracted financial filters can include the same filters that are manually selected, e.g., an average and/or median down payment percent for an asset (e.g., a home, a car, a building), an average and/or median mortgage, and average and/or median other asset loans (e.g., vehicle loans), and average and/or median income per resident and/or per household, an average and/or median total savings per resident and/or per household, an average and/or median savings rate per resident and/or per household, an average and/or median net worth per resident and/or per household, an average and/or median number of credit cards per resident and/or per household, and average and/or median credit card debt per resident and/or per household, an average and/or median savings per account type (e.g., bank savings account, retirement accounts such as 401K accounts and IRA accounts), an average and/or median for miscellaneous investment accounts, an average and/or median cryptocurrency investment per cryptocurrency (e.g., Bitcoin, Ethereum, Doge coin, and so on), an average and/or median rent, an average and/or median utilities spending per utility category (e.g., electricity, water, gas, heating oil, internet, cellphone), an average and/or median grocery spending per resident and/or per household, an average and/or median travel spending per resident and/or per household, an average and/or median transportation spending per resident and/or per household, an average and/or median entertainment spending per resident and/or per household, an average and/or median childcare cost per child and/or per household, an average and/or median pet care cost per resident and/or per household, an average and/or median healthcare spending by healthcare category (e.g., preventative care, emergency healthcare, dental, elder care, and so on) per resident and/or per household, or a combination thereof.

The user can select a percent match for the source geographic area, for example, so that the user selects how close the financial filters extracted from the source geographic area will match target geographic areas. For example, the user can select a range, e.g., 90%-95%, and the financial filters automatically have their ranges adjusted so that when applied, the 90-95% ranges are used. The user can manually modify any value or range of values for each of the extracted financial filters, or add/remove extracted financial filters. Indeed, the user can also remove some of the filters extracted so that a subset of the financial filters is used instead of the full set of financial filters, or add more financial filters to use.

Once the selection of the one or more financial filters and the target geographic area are provided, the process 100 applies, at block 106, the selected financial filters to one or more data stores. For example, the process 100 can access a variety of data sources, including but not limited to public data stores, private data stores, semi-private data stores, and anonymous data. The public data stores include state, county, city, and other municipalities tax assessment databases, census databases, and/or governmental agency databases (e.g., U.S. Bureau of Economic Analysis databases, U.S. Department of Commerce databases, Small Business Bureau databases). Data stores can also include semi-private data stores such as homeowner association databases, investment club databases, discount club databases, and so on. Private data stores can include bank data bases, data stores from non-governmental entities (NGOs), insurance databases, investment company databases, cryptocurrency exchanges, and so on. Non-public data from semi-private and private data stores is anonymized to comply with corresponding jurisdictional laws and regulations. For example, personally identifiable information (PII), such as name, social security information, addresses, and the like, are removed or otherwise made unidentifiable according to federal, state, and local laws or regulations.

The data stores can also include geographically-based financial advice, for example, provided by residents of a geographic area. For example, some of the residents of certain geographic areas, such as a neighborhood, can share, e.g., anonymously, how they fulfilled certain loan obligations, how they saved for a child's college (e.g., via a 529 college savings plan, via custodial accounts, and so on), how they provisioned retirement account(s), how they created a retirement plan, how they acquired a certain asset by a certain time, how they shop for groceries (e.g., percentage of shopping a local stores, at farmer's markets, at large grocery stores), and the like. Geographically-based financial advice can also be provided by local bank offices, branch offices, local financial institutions, and so on, such as how to take advantage of municipal investments, how to open a local bank account, how to take advantage of local tax credits, and so on.

The various data stores are searched, at block 106, based on the financial filters received. For example, queries such as structured query language (SQL) is used for relational databases, including geographic information system (GIS) extensions to SQL, to match the financial filters to geographic areas (e.g., neighborhoods) located inside of the target geographic area. Likewise, GIS-specific application programming interfaces (APIs) can be used to map between geographic areas and financial databases in order to match the financial filters to certain geographic areas. The data stores can also include object oriented (00) databases, network databases, No-SQL databases, and the like, that link or otherwise relate financial information to one or more geographical areas. Ranked queries, weighted queries, pivot tables, sorting techniques, or a combination thereof, can be used to apply the financial filters to the data stores to match one or more geographic areas by mapping financial databases with geographic databases. Accordingly, a set (e.g., one or more) of matched geographic areas can be found, that have the desired financial filter values or ranges. For example, if the Exton neighborhood in the city of Philadelphia (e.g., the selected geographic area for filtering) has an average down payment for homes of $72,000 and a financial filter for average down payment of homes having a range of between $50,000 and $80,000 has been selected, then the Exton neighborhood matches the financial filter when the financial filter is applied at block 106 to the city of Philadelphia. It is to be noted that more than one geographic area disposed as part of the target geographic area can match the selected financial filters and filter values.

The process 100 then retrieves, at block 108, financial information associated with each matched geographic area of the set of matched geographic areas. The financial information retrieved can include an average and/or median down payment percent for an asset (e.g., a home, a car, a building), an average and/or median mortgage, and average and/or median other asset loans (e.g., vehicle loans), and average and/or median income per resident and/or per household, an average and/or median total savings per resident and/or per household, an average and/or median savings rate per resident and/or per household, an average and/or median net worth per resident and/or per household, an average and/or median number of credit cards per resident and/or per household, and average and/or median credit card debt per resident and/or per household, an average and/or median savings per account type (e.g., bank savings account, retirement accounts such as 401K accounts and IRA accounts), an average and/or median for miscellaneous investment accounts, an average and/or median cryptocurrency investment per cryptocurrency (e.g., Bitcoin, Ethereum, Doge coin, and so on), an average and/or median rent, an average and/or median utilities spending per utility category (e.g., electricity, water, gas, heating oil, internet, cellphone), an average and/or median grocery spending per resident and/or per household, an average and/or median travel spending per resident and/or per household, an average and/or median transportation spending per resident and/or per household, an average and/or median entertainment spending per resident and/or per household, an average and/or median childcare cost per child and/or per household, an average and/or median pet care cost per resident and/or per household, an average and/or median healthcare spending by healthcare category (e.g., preventative care, emergency healthcare, dental, elder care, and so on) per resident and/or per household, or a combination thereof.

In some examples, the process 100 also retrieves demographic information for each of the matched geographic areas. The demographic information can include percentage of residents that are married, percentage of residents that have children, average and/or median number of residents by age, education level of residents, population density, number of households, type of households (e.g., single parent households, multigenerational households), number of pets per household, race and ethnicity information, total number of businesses, types of businesses, employee population per business, and so on. The process 100 then presents, at block 110, the set of matched geographic areas, the financial information for each geographic area, and/or the demographic information. The presentation of each of the matched geographic areas, the financial information for each matched geographic area, and/or the demographic information can include multiple presentation types, as well as financial advice from residents and other parties, and focused adverts or offers, as further described below.

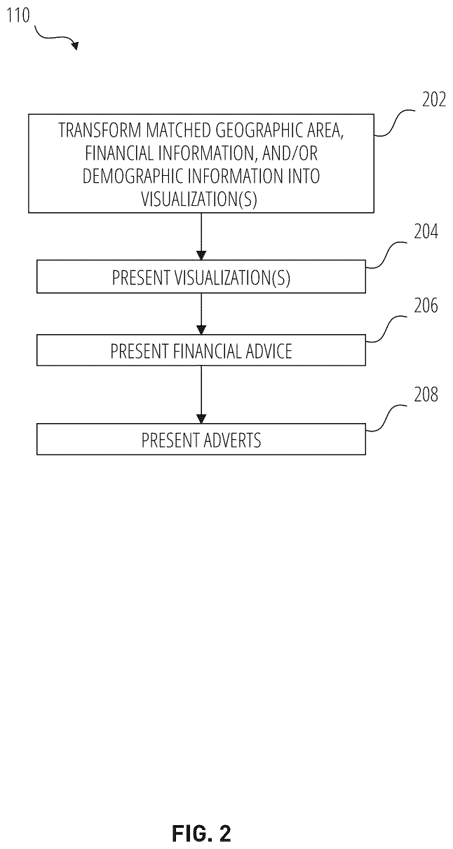

Turning now to FIG. 2, the figure is a flowchart showing further details of block 110 that presents a set of matched geographic areas and related financial and/or demographic information, adverts, and advice, in accordance with an example. In the depicted example, the matched geographic information, the financial information, and/or the demographic information are transformed or otherwise converted, at block 202, into one or more visualizations. The visualizations include both graphical as well as textual visualizations. Textual visualizations, for example, include spreadsheets, lists of the financial and/or demographic information, tables with the financial and/or demographic information, and so on. Graphical visualizations include graphs and charts of various types (e.g., line graphs, bar graphs, radar graphs, pie charts, etc.), as well as augmented reality (AR), and/or virtual reality (VR). An AR visualization, sometimes referred to as a mixed reality visualization, includes the application of virtual content to a real-world environment whether through presentation of the virtual content by transparent displays through which a real-world environment is visible or through augmenting image data to include the virtual content overlaid on real-world environments depicted therein. A virtual reality (VR) visualization includes a completely simulated or “virtual” view of a world is presented through a display device.

The AR and/or VR visualizations can include creating avatars based on representative members (e.g., demographically representative members) of the average/median family in each of the matched geographic areas. For example, the financial and/or demographic information retrieved for a geographic area that was matched by the application of the financial filters can then be used to construct virtual avatar representations so that the information presented is more engaging and immersive when compared, for example, to reading data from a table. Likewise, financial and/or demographic information retrieved from the geographic area can then be used creating virtual structures (e.g., residential properties, rental properties, office buildings, stores, other places of business and recreation) representative of the financial and/or demographic make-up of the matched geographic region.

The visualizations may then be presented, at block 204 for example, via a variety of GUIs, (e.g., web-based GUIs, app-based GUIs, GUIs disposed in VR/AR devices such as smart glasses, headpieces, and smartphones) that can provide immersive walk-throughs, 3D views, and the like, suitable for engaging the user in a more immersive manner. The user can see and interact with the avatar and with the virtual structures and objects presented. For example, the user can walk through a virtual location and at a glance see a visual representation of financial and demographic properties of the geographic area that has been matched by seeing the virtual structures and avatars that have been created. The users can also engage with the avatars, for example, asking avatars about where to shop for certain items, learning to save for certain goals, and discovering financing products and offers, among others.

Indeed, during the presentation of the visualizations at block 204, the user may be provided, at block 206, with certain financial advice. For example, a user may navigate to certain avatars, virtual objects, and/or virtual locations, and pop-ups or other GUI elements can appear, detailing that financial advice is available. As mentioned earlier, certain residents or other entities can provide financial advice, such as how they fulfilled payment on a mortgage early, how they paid for a certain asset, how they saved for or otherwise paid for college, how they provisioned retirement account(s), how the created a retirement plan, how to acquire a certain asset, how they shop for groceries, for insurance, and so on. Indeed, the financial advice presented can include fulfilling a loan obligation, saving for college, creating a retirement plan, creating an emergency fund account, acquiring an asset, acquiring insurance, shopping advice, investing advice Geographically-based financial advice can also be provided by local bank offices, branch offices, insurance companies, and other financial institutions.

The user is additionally presented, at block 208, with certain adverts and product offerings. For example, the user can engage with avatars, with virtual objects, and/or with virtual locations to discover geographically targeted product offerings, including financial product offerings (e.g, checking accounts, savings accounts, college savings plans, retirement accounts, investment accounts, business accounts), travel product offerings, as well as offerings for household goods, furnishings, clothing, transportation services (e.g., local rail discounts, bus discounts), vehicle discounts, personal services (e.g., hairstylists, barbers, cosmetologists), healthcare services (e.g., medical services, preventative care services), etc. In some examples, the users can additionally or alternatively communicate with a customer support specialist to ask questions, hear further offer details, and to procure the products offered. It is to be noted that the financial advice at block 206 and the advertising presented at block 208 can also be presented via non-VR/AR techniques, such as via textual documents, spreadsheets, tables, lists, reports, and so on. By providing for various presentations of financial and demographic information for a matched geographic area, the techniques described herein provide for more efficient and engaging visualizations.

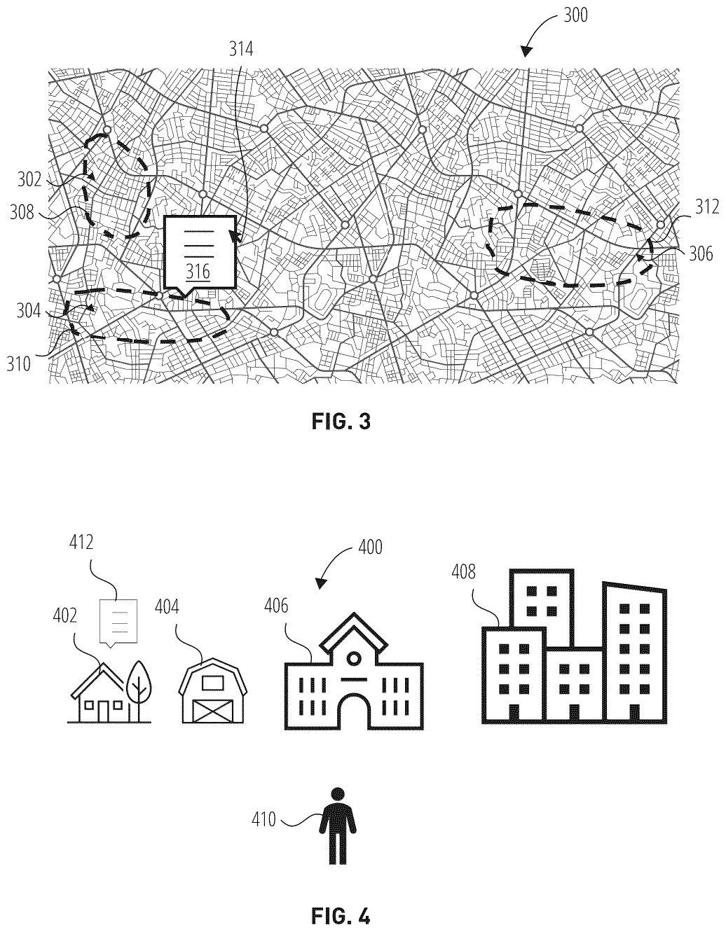

Turning now to FIG. 3, the figure is a map display 300 of a set of three matched geographic areas 302, 304, 306 in accordance with an example. More specifically, the matched geographic areas 302, 304, 306 shown have been matched after a user has selected one or more financial filters as described above with respect to FIG. 1, set certain desired values for the financial filters, and the filters have then been applied via querying one or more data stores. The result of the application of the financial filters is then displayed in various ways, such as the map display 300 shown. The results can also be displayed as lists in a GUI list box, in spreadsheets, as tables, and so on.

In the depicted example, each geographic area 302, 304, 306 is shown with dashed boundary lines 308, 310, 312, representative of geographic bounds for each of the geographic area 302, 304, 306. The user can select a geographic area 302, 304, 306, for example, by navigating a GUI pointer element 314 into the desired geographic area 302, 304, 306 to bring up further information and/or selections for each of the geographic areas 302, 304, 306.

In the depicted example, a pop-up GUI element 316 is shown, which activates when the user's GUI pointer element 314 enters the geographic area 304 or is activated by the user. The pop-up GUI element 316 can include information for the geographic area 304 as well as a list of further actions that may be taken. For example, summary information for the geographic area 304, such as name (e.g., neighborhood name), number of homes, population, and the like, may be presented. The list of further actions can include requests for detailed financial and/or demographic information for the geographic area, e.g., geographic area 304, such as a report, graphs, charts, and so on.

As mentioned earlier, the financial information for the geographic areas 302, 304, 306 includes an average and/or median down payment percent for an asset (e.g., a home, a car, a building), an average and/or median mortgage, and average and/or median other asset loans (e.g., vehicle loans), and average and/or median income per resident and/or per household, an average and/or median total savings per resident and/or per household, an average and/or median savings rate per resident and/or per household, an average and/or median net worth per resident and/or per household, an average and/or median number of credit cards per resident and/or per household, and average and/or median credit card debt per resident and/or per household, an average and/or median savings per account type (e.g., bank savings account, retirement accounts such as 401K accounts and IRA accounts), an average and/or median for miscellaneous investment accounts, an average and/or median cryptocurrency investment per cryptocurrency (e.g., Bitcoin, Ethereum, Doge coin, and so on), an average and/or median rent, an average and/or median utilities spending per utility category (e.g., electricity, water, gas, heating oil, internet, cellphone), an average and/or median grocery spending per resident and/or per household, an average and/or median travel spending per resident and/or per household, an average and/or median transportation spending per resident and/or per household, an average and/or median entertainment spending per resident and/or per household, an average and/or median childcare cost per child and/or per household, an average and/or median pet care cost per resident and/or per household, an average and/or median healthcare spending by healthcare category (e.g., preventative care, emergency healthcare, dental, elder care, and so on) per resident and/or per household, or a combination thereof. Demographic information for the geographic areas 302, 304, 306 include percentage of residents that are married, percentage of residents that have children, average and/or median number of residents by age, education levels of residents, population density, number of households, type of households (e.g., single parent households, multigenerational households), number of pets per household, race and ethnicity information, total number of business, types of businesses, employee population per business, or the like.

The list of further actions presented, for example, via the pop-up GUI element 316, also includes virtual reality (VR) and/or augmented reality (AR) visualizations. For example, and turning now to FIG. 4, an example visualization 400 is shown, that includes several virtual structure types 402, 404, 406, 408 created by using financial and/or demographic information from the matched geographic area 302 and an avatar 410 representative of the user. The visualization 400 can be presented as a VR visualization, an AR visualization, or a combination thereof. Each of the virtual structure types 402, 404, 406, 408 are representative of structure types found, for example, in the matched geographic area 302. That is, the financial and/or demographic information for the geographic area 302 has been used to virtually create the structure types 402, 404, 406, 408 by deriving a percentage of residential homes, farms, apartment complexes, and office buildings found in the geographic area 302. Accordingly, the virtual structure types 402, 404, 406, 408 are visually representative of a residential home, a farm, an apartment complex, and an office building, respectively.

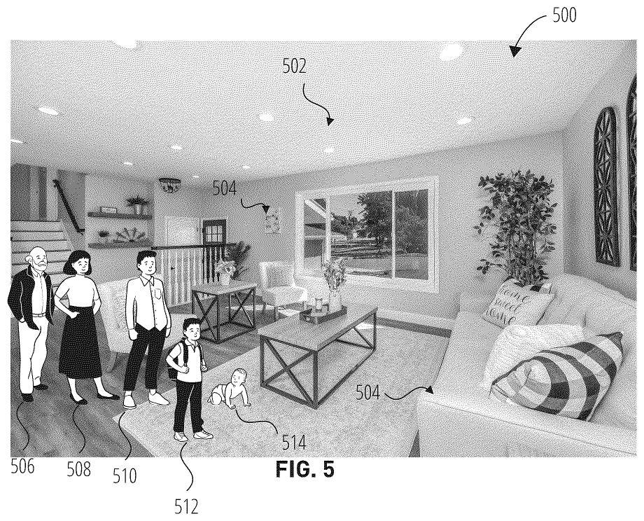

In some examples, the virtual structure types 402, 404, 406, 408 are ordered for display purposes based on the total number of structures of a given type found in the geographic area 302. For example, a left-to-right ordering may be used to denote that the leftmost virtual structure type has the highest count in the geographic area 302, and that the rightmost virtual structure type has the lowest count. The ordering can also include ordering by population, such that the leftmost virtual structure type is representative of the structure type having the highest residential population in the geographic area 302. The ordering can additionally include ordering by real estate value, such that the leftmost virtual structure type is representative of the structure type having the highest real estate value in the geographic area 302. The user 410 can select a virtual structure type to either see more financial and/or demographic information, e.g., via a pop-up GUI element 412, via reports, and/or by entering into the virtual structure, e.g., the virtual structure 402, via AR, and/or VR techniques as shown in FIG. 5.

FIG. 5 illustrates a visualization 500 of an interior space 502 according to one example. More specifically, the interior space 502 corresponds to the interior of the virtual structure 402 and is used for a virtual walk-through of the virtual structure 402. In some VR, and/or AR examples, the interior space 502 is created based on financial and demographic information. That is, information retrieved for the geographic area 302, such as residential information including average/median square footage for residences, number of floors, number of bedrooms, number of bathrooms, lot size, construction date, a building type (e.g., a condominium, a townhouse, a standalone house, an apartment), a type of heating system used (e.g., electrical furnace, gas furnace, oil furnace), a type of air conditioning (AC) system used (e.g., central AC, ductless AC, geothermal AC, window AC), a building decor (e.g., furnishings, household goods, art) and so on, is then used to construct the interior space 502. Indeed, a virtual residence, including the interior space 502, can be automatically constructed, based on the residential information. For example, a two-story, 1800 square feet house having 3 bedrooms, 2 bathrooms, a gas furnace, and central AC can be constructed virtually having a residential architecture representative of the early 1980's, aged to resemble a house built in the 1980's, based on the retrieved residential information for the geographic area 302.

Likewise, financial and/or demographic information can be used to virtually furnish the home. For example, the most frequented stores (e.g., big box stores, local stores, internet-based stores) in the geographical area 302 can be used to automatically place equivalent virtual building decor items 504 such as furniture, rugs, art, and the like. Financial spending information that tracks level of spending, for example, can also be used to derive the type of decor items 504 to include in the interior space 502.

In the depicted example, a family of avatars 506, 508, 510, 512, 514 “living” in the virtual structure 402 of the geographic area 302 is shown. The example family is a multigeneration family that is created for the visualization walk-through via the demographic information retrieved for the geographic area 302. More specifically, the multigenerational status, age, race, gender, and number of children for the family of avatars 506, 508, 510, 512, 514 is derived from demographic data and the avatars 506, 508, 510, 512, 514 are then automatically created to reflect the demographic data. In the depicted example the median family is a multigenerational family with an older male, a male/female couple, and two children. Accordingly, the avatar 506 is representative of the older male, the avatar 508 is representative of the mother, the avatar 510 is representative of the father, the avatar 510 is representative of a first child, and the avatar 514 is representative of a younger second child. It is to be understood that while the median family is shown, the average family may also be derived in the same manner.

The user can navigate through the interior space 502 to view furnishings, to inspect the virtual structure 402, and/or interact with the family of avatars 506, 508, 510, 512, 514 in an immersive manner. For example, each of the avatars 506, 508, 510, 512, 514 includes outfits selected from the preferred clothing stores, shoe stores, and/or accessories stores in the geographic area 302. Accordingly, the user, can walk into the interior space 502, visually inspect the interior space 502 layout, perceive the different furnishings used, and see the avatars, thus experiencing how the average and/or median resident lives in the structure type selected for the walk-through in a more efficient manner.

In some examples, advice and/or offers are presented to the user during the walk-through. That is, as the user virtually inspects certain products, such as products for the home, clothing, groceries, artwork, and the like, product offerings may popup, detailing certain discounts or other incentives. In some examples, various local retailers can purchase ad space used during the virtual walk-throughs. Likewise, the user can interact with certain avatars of the avatar family 506, 508, 510, 512, 514 to ask for advice relevant to the geographic area. For example, the avatars may provide information that has been volunteered by various residents of the geographic area 302, which includes financial advice, such as how the residents are investing e.g., “I transfer 20% of my paycheck each month into a high-yield investment account”, “all my debts were paid off when I got an inheritance with the exception of mortgage for tax purposes”, “I transferred $10k of high interest credit card debt on to a home equity loan to reduce my payment”, paying for college, how they created a retirement plan, how they acquired a certain asset (e.g., car, house), how they started a “for emergencies” fund, etc. In some examples, local, regional, and other financial entities such as banks, investment funds, insurance companies, and the like, can also offer complementary financial advice and financial products. For example, college savings plans such as 529 plans can be offered, along with advice on how to provision the 529 plans for college attendance.

Likewise, retirement plans (e.g., 401K plans, individual retirement accounts (IRAs), retirement account rollovers), checking accounts, savings accounts, investment accounts, cryptocurrency accounts, and so on, can be offered to the user. In some examples, the user can communicate with a customer service person to ask more questions or to buy the products, including the financial products, being offered. Advise provide may also include local shopping advice (e.g., “we use Pete's grocery store, they are a local grocer and use products from the farming community”), car shopping, finding house movers, local transportation tips (e.g., “the new rail systems work well but shuts down early evening”), hair stylists, and so on. By providing for immersive visualizations to see financial and/or demographic information of certain geographic areas of interest and provide local advice, the techniques described herein can improve on efficiency of information presentation and engagement.

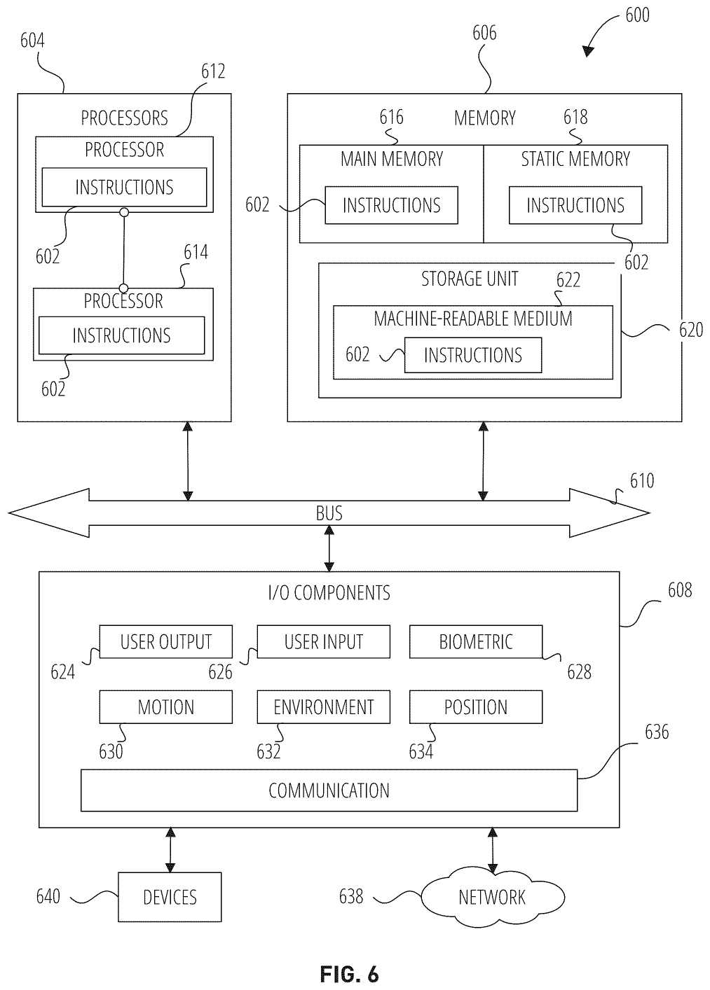

FIG. 6 is a diagrammatic representation of a machine 600 within which instructions 602 (e.g., software, a program, an application, an applet, an app, or other executable code) for causing the machine 600 to perform any one or more of the methodologies discussed herein may be executed. For example, the instructions 602 may cause the machine 600 to execute any one or more of the processes or methods described herein, such as the process 100 and the process 110. The instructions 602 transform the general, non-programmed machine 600 into a particular machine 600, e.g., a geofinancial matching system, programmed to carry out the described and illustrated functions in the manner described. The machine 600 may operate as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 602, sequentially or otherwise, that specify actions to be taken by the machine 600. Further, while a single machine 600 is illustrated, the term “machine” shall also be taken to include a collection of machines that individually or jointly execute the instructions 602 to perform any one or more of the methodologies discussed herein. In some examples, the machine 600 may also comprise both client and server systems, with certain operations of a particular method or algorithm being performed on the server-side and with certain operations of the particular method or algorithm being performed on the client-side.

The machine 600 may include processors 604 (e.g., hardware processors), memory 606, and input/output I/O components 608, which may be configured to communicate with each other via a bus 610. In an example, the processors 604 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application-Specific Integrated Circuit (ASIC), a Radio-Frequency Integrated Circuit (RFIC), another processor, or any suitable combination thereof) may include, for example, a processor 612 and a processor 614 that execute the instructions 602. The term “processor” is intended to include multi-core processors that may comprise two or more independent processors (sometimes referred to as “cores”) that may execute instructions contemporaneously. Although FIG. 6 shows multiple processors 604, the machine 600 may include a single processor with a single-core, a single processor with multiple cores (e.g., a multi-core processor), multiple processors with a single core, multiple processors with multiples cores, or any combination thereof.

The memory 606 includes a main memory 616, a static memory 618, and a storage unit 620, both accessible to the processors 604 via the bus 610. The main memory 616, the static memory 618, and storage unit 620 store the instructions 602 embodying any one or more of the methodologies or functions described herein. The instructions 602 may also reside, completely or partially, within the main memory 616, within the static memory 618, within machine-readable medium 622 within the storage unit 620, within at least one of the processors 604 (e.g., within the processor's cache memory), or any suitable combination thereof, during execution thereof by the machine 600.

The I/O components 608 may include a wide variety of components to receive input, provide output, produce output, transmit information, exchange information, capture measurements, and so on. The specific I/O components 608 that are included in a particular machine will depend on the type of machine. For example, portable machines such as mobile phones may include a touch input device or other such input mechanisms, while a headless server machine will likely not include such a touch input device. It will be appreciated that the I/O components 608 may include many other components that are not shown in FIG. 6. In various examples, the I/O components 608 may include user output components 624 and user input components 626. The user output components 624 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 626 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 608 may include biometric components 628, motion components 630, environmental components 632, or position components 634, among a wide array of other components. For example, the biometric components 628 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 630 include acceleration sensor components (e.g., accelerometer), gravitation sensor components, rotation sensor components (e.g., gyroscope).

The environmental components 632 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 634 include location sensor components (e.g., a global positioning system (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 608 further include communication components 636 operable to couple the machine 1200 to a network 638 or devices 640 via respective coupling or connections. For example, the communication components 636 may include a network interface component or another suitable device to interface with the network 638. In further examples, the communication components 636 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 640 may be another machine or any of a wide variety of peripheral devices (e.g., a peripheral device coupled via a universal serial bus (USB) port), internet-of-things (IoT) devices, and the like.

Moreover, the communication components 636 may detect identifiers or include components operable to detect identifiers. For example, the communication components 636 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 636, such as location via Internet Protocol (IP) geolocation, location via Wi-Fi® signal triangulation, location via detecting an NFC beacon signal that may indicate a particular location, and so forth.

The various memories (e.g., main memory 616, static memory 618, and memory of the processors 604) and storage unit 620 may store one or more sets of instructions and data structures (e.g., software) embodying or used by any one or more of the methodologies or functions described herein. These instructions (e.g., the instructions 602), when executed by processors 604, cause various operations to implement the disclosed examples.

The instructions 602 may be transmitted or received over the network 638, using a transmission medium, via a network interface device (e.g., a network interface component included in the communication components 636) and using any one of several well-known transfer protocols (e.g., hypertext transfer protocol (HTTP)). Similarly, the instructions 602 may be transmitted or received using a transmission medium via a coupling (e.g., a peer-to-peer coupling) to the devices 640. In some examples, the machine 600 and/or the one or more of the devices 640 at virtual reality devices, augmented reality devices, and/or mixed reality devices suitable for presenting the visualizations described herein, such as the visualizations presented at block 204 of FIG. 2.

The techniques described herein provide for the techniques described herein provide for automating the analysis, comparison, and the creation of visualizations of geographic areas such as neighborhoods filtered on certain financial data. In one example, a user can enter a set of financial filters (e.g., home down payment percent, income, spending habits of residents, and so on) and a target geographic area to apply the financial filters to. The filters are then applied to match a set of geographic areas located within the target geographic area based on the financial filters entered. The geographic areas can include a state, a city, a county, a municipality, one or more neighborhoods, and/or a subarea within a neighborhood. In certain examples, the financial filters can also be automatically extracted for matching, for example, by selecting a source geographic area to extract the financial filters from. Accordingly, the user can select a specific neighborhood as the source geographic area to find other financially similar geographic areas based on the automatically extracted financial filters. Financial advice from residents and product offers targeted to the matched geographic areas are also provided.

1. A method comprising:
providing, via a processor, a list of financial filters;
receiving, via the processor, from a user, a selection of one or more of the financial filters and a target geographic area;
applying, via the processor, the selection of the one or more financial filters and the target geographic area to match a set of geographic areas from a data store, wherein the set of matched geographic areas are geographically included as part of the target geographic area, and wherein the set of matched geographic areas are determined based on a first data store query of the data store determining that the set of matched geographic areas comprise economic data matching the one or more financial filters;
retrieving, from the data store via a second data store query, financial information, demographic information, or a combination thereof, for the set of matched geographic areas when a match is found;
generating a resident-based financial advice based on the set of matched geographic areas, wherein the resident-based financial advice comprises financial data retrieved from an anonymized financial advice profile of one or more residents in the set of matched geographic areas;
presenting, via an interactive graphical user interface on a display, an interactive map interface depicting the set of matched geographic areas, the financial information, the demographic information, or a combination thereof; and
presenting the resident-based financial advice generated based on the set of matched geographic areas.

2. The method of claim 1, wherein the resident-based financial advice comprises advice on fulfilling a loan obligation, saving for college, creating a retirement plan, creating an emergency fund account, acquiring an asset, acquiring insurance, shopping advice, investing advice, or a combination thereof.

3. The method of claim 2, wherein the resident-based financial advice comprises advice provided by the one or more residents of the set of matched geographic areas, by a financial institution, or by a combination thereof.

4. The method of claim 1, wherein receiving, via the processor, from the user, the selection of the one or more of the financial filters comprises receiving a source geographic area from the user and extracting the one or more financial filters from the source geographic area.

5. The method of claim 4, wherein receiving the source geographic area from the user comprises receiving a percentage match for the source geographic area and wherein value ranges for the financial filters are adjusted based on the percentage match.

6. The method of claim 1, wherein applying, via the processor, the selection of the one or more financial filters comprises ranking the selection of the one or more financial filters to derive one or more ranked financial filters and applying, via the processor, the ranked financial filters and the target geographic area to match the set of matched geographic areas from the data store.

7. The method of claim 6, wherein at least one of the one or more ranked financial filters comprises a ranking weight.

8. The method of claim 1, wherein the one or more financial filters comprise an average or median value or an average or median range of values for:
a down payment percent for an asset, a mortgage, a vehicle loan, an income per resident, and income per household, a total savings amount per resident, a total savings amount per household, a savings rate per resident, a savings rate per household, a net worth per resident, a net worth per household, a total number of credit cards per resident, a total number of credit cards per household, a credit card debt amount per resident, a credit card debt amount per household, a savings per savings account type, a cryptocurrency investment per cryptocurrency, a rent, a utilities spending by utility category, a travel spending, a grocery spending per resident, a grocery spending per household, a transportation spending per resident, a transportation spending per household, an entertainment spending per resident, an entertainment spending per household, a childcare cost per child, a childcare cost per household, a pet care cost per resident, a pet care cost per household, a healthcare spending by healthcare category per resident, a healthcare spending by healthcare category per household, or a combination thereof.

9. The method of claim 1, wherein presenting, via the display, the set of matched geographic areas, the financial information, the demographic information, or the combination thereof, comprises transforming the financial information, the demographic information, or the combination thereof, into a virtual building, into one or more avatars, into a virtual location, or into a combination thereof, representative of the financial information, the demographic information, or the combination thereof, and presenting, via the display, the virtual building, the one or more avatars, the virtual location, or the combination thereof, in an augmented reality (AR) visualization, in a virtual reality (VR) visualization, or in a combination thereof.

10. The method of claim 9, wherein presenting, via the display, the set of matched geographic areas, the financial information, the demographic information, or the combination thereof, comprises displaying a pop-up graphical element over a matched geographic area included in the set of matched geographic areas, over the virtual building, over the one or more avatars, over the virtual location, or over a combination thereof, and wherein the graphical element includes the financial information, the demographic information, or a combination thereof.

11. The method of claim 9, wherein transforming the financial information into the virtual building comprises extracting a square footage, a number of floors, a number of bedrooms, a number of bathrooms, a lot size, a construction date, a building type, a building decor, or a combination thereof, from a residential information included in the financial information, the demographic information, or the combination thereof, and wherein presenting, via the display, the virtual building, comprises presenting a virtual interior space that displays an interior of the virtual building having the square footage, the number of floors, the number of bedrooms, the number of bathrooms, the lot size, the construction date, the building type, the building decor, or the combination thereof.

12. The method of claim 11, wherein presenting the virtual interior space comprises displaying the one or more avatars inside of the virtual interior space.

13. The method of claim 1, wherein one or more avatars created based on the financial information, the demographic information, or the combination thereof, are configured to present the resident-based financial advice.

14. The method of claim 1, wherein presenting, via the display, the set of matched geographic areas, the financial information, the demographic information, or the combination thereof, comprises presenting product offers relevant to the set of matched geographic areas.

15. The method of claim 14, wherein the product offers are presented based on a walk-through of an augmented reality (AR) visualization, a virtual reality (VR) visualization, or a combination thereof, created to reflect the financial information, the demographic information, or the combination thereof.

16. A non-transitory machine-readable medium storing instructions that, when executed by a computer system, cause the computer system to perform operations comprising:
providing a list of financial filters;
receiving, from a user, a selection of one or more of the financial filters and a target geographic area;
applying the selection of the one or more financial filters and the target geographic area to match a set of matched geographic areas from a data store, wherein the set of matched geographic areas are geographically included as part of the target geographic area, and wherein the set of matched geographic areas comprise economic data matching the one or more financial filters;
retrieving, from the data store via a second data store query, financial information, demographic information, or a combination thereof, for the set of matched geographic areas when a match is found;
generating a resident-based financial advice based on the set of matched geographic areas, wherein the resident-based financial advice comprises financial data retrieved from an anonymized financial advice profile of one or more residents in the set of matched geographic areas;
presenting, via an interactive graphical user interface on a display, an interactive map interface depicting the set of matched geographic areas, the financial information, the demographic information, or a combination thereof; and
presenting the resident-based financial advice generated based on the set of matched geographic areas.

17. The non-transitory machine-readable medium storing instructions of claim 16, wherein the one or more financial filters comprise an average and/or median value or an average and/or median range of values for:
a down payment percent for an asset, a mortgage, a vehicle loan, an income per resident, and income per household, a total savings amount per resident, a total savings amount per household, a savings rate per resident, a savings rate per household, a net worth per resident, a net worth per household, a total number of credit cards per resident, a total number of credit cards per household, a credit card debt amount per resident, a credit card debt amount per household, a savings per savings account type, a cryptocurrency investment per cryptocurrency, a rent, a utilities spending by utility category, a travel spending, a grocery spending per resident, a grocery spending per household, a transportation spending per resident, a transportation spending per household, an entertainment spending per resident, an entertainment spending per household, a childcare cost per child, a childcare cost per household, a pet care cost per resident, a pet care cost per household, a healthcare spending by healthcare category per resident, a healthcare spending by healthcare category per household, or a combination thereof.

18. The non-transitory machine-readable medium storing instructions of claim 16, wherein presenting, via the display, the set of matched geographic areas, the financial information, the demographic information, or the combination thereof, comprises transforming the financial information, the demographic information, or the combination thereof, into a virtual building, into one or more avatars, into a virtual location, or a combination thereof, representative of the financial information, the demographic information, or the combination thereof, and presenting, via the display, the virtual building, the one or more avatars, the virtual location, or the combination thereof, in an augmented reality (AR) visualization, in a virtual reality (VR) visualization, or in a combination thereof.

19. A system, comprising:
one or more hardware processors; and
at least one memory storing instructions that cause the one or more hardware processors to perform operations comprising:
providing a list of financial filters;
receiving, from a user, a selection of one or more of the financial filters and a target geographic area;
applying the selection of the one or more financial filters and the target geographic area to match a set of matched geographic areas from a data store, wherein the set of matched geographic areas are geographically included as part of the target geographic area, and wherein the set of matched geographic areas are determined based on a first data store query of the data store determining that the set of matched geographic areas comprise economic data matching the one or more financial filters;
retrieving, from the data store via a second data store query, financial information, demographic information, or a combination thereof, for the set of matched geographic areas when a match is found;
generating a resident-based financial advice based on the set of matched geographic areas, wherein the resident-based financial advice comprises financial data retrieved from an anonymized financial advice profile of one or more residents in the set of matched geographic areas;
presenting, via an interactive graphical user interface on a display, an interactive map interface depicting the set of matched geographic areas, the financial information, the demographic information, or a combination thereof; and
presenting the resident-based financial advice generated based on the set of matched geographic areas.

20. The system of claim 19, wherein presenting, via the display, the set of matched geographic areas, the financial information, the demographic information, or the combination thereof, comprises presenting the resident-based financial advice relevant to the set of matched geographic areas provided by residents of the set of matched geographic areas, presenting product offers relevant to the set of matched geographic areas, or a combination thereof.
